(19) United States
(12) Patent Application Publication
(10) Pub. No.: US 2017/0305198 A1
(43) Pub. Date: Oct. 26, 2017

(54) Pneumatic Tire

(71) Applicant: The Yokohama Rubber Co. LTD., Minato-ku, Tokyo (JP)

(72) Inventor: Akihiro Ichimura, Hiratsuka-shi, Kanagawa (JP)

(21) Appl. No.: 15/517,940

(22) PCT Filed: Oct. 5, 2015
(86) PCT No.: PCT/JP2015/078194

§ 371 Date: Apr. 7, 2017

(30) Foreign Application Priority Data
Oct. 9, 2014 (JP) 2014-207967

(51) Int. Cl. B60C 11/03; B60C 13/02; B60C 11/12; B60C 11/01

(52) U.S. Cl. CPC B60C 11/03; B60C 13/02; B60C 11/1236; B60C 11/033; B60C 11/01

(57) ABSTRACT

Provided is a pneumatic tire. Distances from a tire equator of the first to third main grooves and narrow groove respectively are from 5% to 20%, 20% to 35%, 55% to 70%, and 40% to 60% of a tire ground contact half-width TL/2. First lug grooves reach a ground contact edge on a vehicle inner side and terminate within a first rib, second lug grooves communicate with the third main groove and terminate in a second rib, third lug grooves communicate with the second main groove and terminate within a third rib, fourth lug grooves communicate with the first main groove and terminate within a fourth rib, fifth lug grooves intersect the narrow groove and terminate within the fourth rib and a fifth rib, and sixth lug grooves reach a ground contact edge on the vehicle outer side and terminate within the fifth rib.

### TECHNICAL FIELD

The present technology relates to a pneumatic tire, and more specifically relates to a pneumatic tire capable of achieving good wet performance, dry performance, uneven wear resistance performance, and noise performance in a highly compatible manner.

### BACKGROUND ART

There is a demand for conventional pneumatic tires to be enhanced in a highly compatible manner in terms of dry performance (for example, steering stability performance and travel time on dry road surfaces) and wet performance (for example, steering stability performance and hydroplaning resistance performance on wet road surfaces). Enhancements in terms of tire wear resistance performance (in particular uneven wear) and noise performance (for example, pass-by noise) are also demanded in addition to these performances.

One known method of improving wet performance includes disposing a plurality of grooves in a tread portion of a pneumatic tire to improve drainage properties. However, by simply increasing the number of grooves, tread rigidity decreases and thus sufficient dry performance and uneven wear resistance performance cannot be obtained. Additionally, depending on the shape and arrangement of the grooves, pass-by noise is more likely to be caused thus decreasing noise performance. This shows that the number, shape, and arrangement of grooves need to be considered in enhancing the various performances in a compatible manner.

For example, Japanese Unexamined Patent Application Publication No. 2010-215221A describes a tire, as illustrated in FIG. 4, that includes two main grooves disposed in a region on the vehicle inner side of a tire equator; one main groove disposed in a region on the vehicle outer side of the tire equator; a narrow groove disposed in a region on the vehicle outer side of the main groove disposed in the region on the vehicle outer side of the tire equator, the narrow groove having a groove width less than that of the main grooves; land portions defined by the main grooves and the narrow groove; a lug groove disposed in a land portion of the land portions located on the vehicle inner side of the narrow groove, the lug groove having a first end portion on the vehicle inner side that reaches a ground contact edge or one of the main grooves and a second end portion on the vehicle outer side that terminates within the land portion; and a lug groove disposed in the land portion adjacent to the narrow groove that intersects the narrow groove, the lug groove having a first end portion on the vehicle inner side that terminates within the land portion and an end portion on the vehicle outer side that reaches the ground contact edge. In such a tread pattern, the lug groove that communicates with the main groove terminates within the land portion. As a result, good drainage performance can be obtained while maintaining dry performance without significantly reducing tread rigidity. Additionally, by the narrow groove being disposed in the region on the vehicle outer side which greatly influences dry performance and uneven wear resistance performance, dry performance and uneven wear resistance performance can be effectively enhanced while maintaining tread rigidity to a high degree in this region. Also, the reduced wet performance caused by the narrow groove with the small groove width can be offset by the lug groove that intersects the narrow groove. As a result, the performances can be enhanced in a compatible manner.

However, with increasing demands for faster vehicle speeds brought about by developments in high performance vehicles and road conditions in recent years, such conventional tread pattern configurations are increasingly unable to provide sufficient performance in a compatible manner especially when vehicles are travelling at high speeds. Additionally, in extreme driving environments such as circuit driving, the level of performance demanded is so high that such conventional tread pattern configurations are becoming insufficient. Thus, there is a demand for further enhancements in achieving good wet performance, dry performance, uneven wear resistance performance, and noise performance in a highly compatible manner.

### SUMMARY

The present technology provides a pneumatic tire capable of achieving good wet performance, dry performance, uneven wear resistance performance, and noise performance in a highly compatible manner.

An embodiment of the present technology provides a pneumatic tire with a specified mounting direction with respect to a vehicle, the pneumatic tire comprising:

an annular tread portion that extends in a tire circumferential direction;

a pair of sidewall portions disposed on both sides of the tread portion;

a pair of bead portions disposed inward of the sidewall portions in a tire radial direction;

a first main groove disposed on a vehicle outer side of a tire equator in the tread portion that extends in the tire circumferential direction;

a second main groove disposed on a vehicle inner side of the tire equator in the tread portion that extends in the tire circumferential direction;

a third main groove disposed on the vehicle inner side of the second main groove in the tread portion that extends in the tire circumferential direction; and

a narrow groove disposed on the vehicle outer side of the first main groove in the tread portion that extends in the tire circumferential direction, a groove width of the narrow groove being less than groove widths of the first to third main grooves;

a distance GL1 from a center position of the first main groove to the tire equator being from 5% to 20% of a half-width TL/2 of a tire ground contact width TL;

a distance GL2 from a center position of the second main groove to the tire equator being from 20% to 35% of the half-width TL/2 of the tire ground contact width TL;

a distance GL3 from a center position of the third main groove to the tire equator being from 55% to 70% of the half-width TL/2 of the tire ground contact width TL;

a distance GL4 from a center position of the narrow groove to the tire equator being from 40% to 60% of the half-width TL/2 of the tire ground contact width TL;

a first rib being disposed on the vehicle inner side of the third main groove;

a second rib being disposed between the third main groove and the second main groove;

a third rib being disposed between the second main groove and the first main groove;

a fourth rib being disposed between the first main groove and the narrow groove;

a fifth rib being disposed on the vehicle outer side of the narrow groove; and

a plurality of first lug grooves, second lug grooves, third lug grooves, fourth lug grooves, fifth lug grooves, and sixth lug grooves being disposed in the tread portion,

the plurality of first lug grooves each including one end that reaches a ground contact edge on the vehicle inner side and another end that terminates within the first rib without communicating with the third main groove,

the plurality of second lug grooves each including one end that communicates with the third main groove and another end that terminates within the second rib,

the plurality of third lug grooves each including one end that communicates with the second main groove and another end that terminates within the third rib,

the plurality of fourth lug grooves each including one end that communicates with the first main groove and another end that terminates within the fourth rib,

the plurality of fifth lug grooves each intersecting the narrow groove and including one end that terminates within the fourth rib and another end that terminates within the fifth rib, and

the plurality of sixth lug grooves each including one end that reaches a ground contact edge on the vehicle outer side and another end that terminates within the fifth rib without communicating with the narrow groove.

According to an embodiment of the present technology, by disposing main grooves that extend in the tire circumferential direction near the tire equator and on the vehicle inner side of the tire equator, efficient drainage can be achieved. By disposing the narrow groove furthest to the vehicle outer side instead of a main groove, tread rigidity can be increased while ensuring sufficient drainage performance in the region. As a result, steering stability performance can be improved while maintaining drainage performance and wet performance. Additionally, the lug grooves include end portions on one side that terminate within the ribs, and the land portions defined by the main grooves and the narrow groove are formed as ribs continuous in the tire circumferential direction. As a result, tread rigidity and thus steering stability performance can be increased. Because the rib is continuous in the tire circumferential direction and the terminating positions of the lug grooves are set as described above, uneven wear can also be suppressed. Accordingly, steering stability performance can be improved while maintaining excellent drainage performance and wet performance, and excellent uneven wear resistance performance can be achieved.

According to an embodiment of the present technology, the groove width of the narrow groove is preferably from 10% to 60% of the groove width of the first main groove. Setting the groove width of the narrow groove in such a manner relative to the groove width of the main groove is advantageous in achieving good wet performance and steering stability performance in a compatible manner.

According to an embodiment of the present technology, the groove widths of the first to third main grooves are preferably from 8 mm to 16 mm, and the groove width of the narrow groove is preferably from 1 mm to 6 mm. Setting the groove width of the grooves in such a manner is advantageous in achieving good wet performance and steering stability performance in a compatible manner.

According to an embodiment of the present technology, a width of the third rib is preferably from 80% to 120% of a width of the second rib. Setting the width of the second rib and the third rib to be equal is advantageous in obtaining sufficient tread rigidity and thus improving steering stability performance.

According to an embodiment of the present technology, opening portions of the second lug grooves and the third lug grooves are preferably offset in the tire circumferential direction, and opening portions of the third lug grooves and the fourth lug grooves are preferably offset in the tire circumferential direction. By not aligning the opening portions of the lug grooves disposed in adjacent ribs, the balance of tread rigidity can be made uniform, and thus steering stability performance and uneven wear resistance performance can be effectively increased.

According to an embodiment of the present technology, the third lug grooves are preferably inclined in an opposite direction to the second lug grooves with respect to a tire width direction, and the fourth lug grooves are preferably inclined in an opposite direction to the third lug grooves with respect to the tire width direction. By setting the inclination direction of lug grooves in such a manner, the balance of tread rigidity can be made uniform, and thus steering stability performance and uneven wear resistance performance can be effectively increased.

According to an embodiment of the present technology, one end proximal to the fourth rib and another end proximal to the fifth rib of each of the fifth lug grooves are preferably located to one side in the tire circumferential direction of a point where the fifth lug groove and the narrow groove intersect. In particular, each of the fifth lug grooves is preferably curved toward one side in the tire circumferential direction. By setting the shape of the fifth lug grooves in such a manner, the force applied to the lug grooves, which are susceptible to damage when braking/driving or when turning, is distributed, and it is thus possible to suppress uneven wear. In particular, by each of the fifth lug grooves being curved toward one side in the tire circumferential direction, enhancements to pass-by noise can be further achieved.

In such embodiments, a curved portion of each of the fifth lug grooves preferably has a radius of curvature of from 8 mm to 50 mm. The fifth lug groove having such a curved shape is advantageous in enhancing uneven wear resistance performance and noise performance.

According to an embodiment of the present technology, a region on the vehicle outer side of the tire equator in the tread portion preferably has a relatively greater groove area ratio than a region on the vehicle inner side of the tire equator in the tread portion;

the groove area ratio of the region on the vehicle outer side of the tire equator in the tread portion preferably ranges from 8% to 25%; and

the groove area ratio of the region on the vehicle inner side of the tire equator in the tread portion preferably ranges from 22% to 40%. Setting the groove area ratios as such is advantageous in achieving good drainage performance and steering stability performance in a compatible manner. Note that in the present technology, “groove area ratio” is the ratio of the groove area in the ground contact region to the area in the ground contact region of the tread portion.

According to an embodiment of the present technology, the first to third main grooves and the narrow groove are preferably chamfered or radiused. This enables sufficient groove volume of the first to third main grooves and the narrow groove to be ensured in the initial period of wear without increasing the groove width. As a result, excellent drainage performance can be achieved while ensuring tread rigidity. Note that in embodiments in which the grooves are chamfered or radiused as such, the groove width is measured using the point of intersection of an extension line of the groove wall and an extension line of the tread surface as a reference.

In the present technology, “ground contact edge” is the end portion in the tire axial direction when the tire is assembled on a regular rim and inflated to the regular internal pressure, and placed vertically upon a flat surface with a regular load applied thereto. “Ground contact width” is the length in the tire axial direction between the left and right ground contact edges. In determining the groove area ratio described above, the ground contact region is defined by this ground contact width. A “regular rim” is a rim defined by a standard for each tire according to a system of standards that includes standards on which tires are based, and refers to a “standard rim” in the case of Japan Automobile Tyre Manufacturers Association (JATMA), refers to a “design rim” in the case of Tire and Rim Association (TRA), and refers to a “measuring rim” in the case of European Tyre and Rim Technical Organisation (ETRTO). “Regular internal pressure” is the air pressure defined by standards for each tire according to a system of standards that includes standards on which tires are based, and refers to a “maximum air pressure” in the case of JATMA, refers to the maximum value in the table of “TIRE ROAD LIMITS AT VARIOUS COLD INFLATION PRESSURES” in the case of TRA, and refers to the “INFLATION PRESSURE” in the case of ETRTO. “Regular inner pressure” is 180 kPa for a tire on a passenger vehicle. “Regular load” is the load defined by standards for each tire according to a system of standards that includes standards on which tires are based, and refers to “maximum load capacity” in the case of JATMA, to the maximum value in the table of “TIRE ROAD LIMITS AT VARIOUS COLD INFLATION PRESSURES” in the case of TRA, and to “LOAD CAPACITY” in the case of ETRTO. If the tire is for use with a passenger vehicle, a load corresponding to 88% of the loads described above is used.

### BRIEF DESCRIPTION OF DRAWINGS

FIG. 1 is a meridian cross-sectional view of a pneumatic tire according to an embodiment of the present technology.

FIG. 2 is a front view illustrating a tread surface of the pneumatic tire according to the embodiment of the present technology.

FIG. 3 is a cross-sectional view illustrating an enlarged view of a main groove of the pneumatic tire of FIG. 1.

FIG. 4 is a front view illustrating a tread surface of a conventional pneumatic tire.

### DETAILED DESCRIPTION

Embodiments of the present technology will be described in detail below with reference to the accompanying drawings. Note that in the present technology, the mounting direction of the pneumatic tire with respect to a vehicle is specified. When the pneumatic tire is mounted on a vehicle, the inner side (side indicated in the drawings by “IN”) with respect to the vehicle of a tire equator CL is defined as the “vehicle inner side” and the outer side (side indicated in the drawings by “OUT”) with respect to the vehicle of the tire equator CL is defined as the “vehicle outer side”.

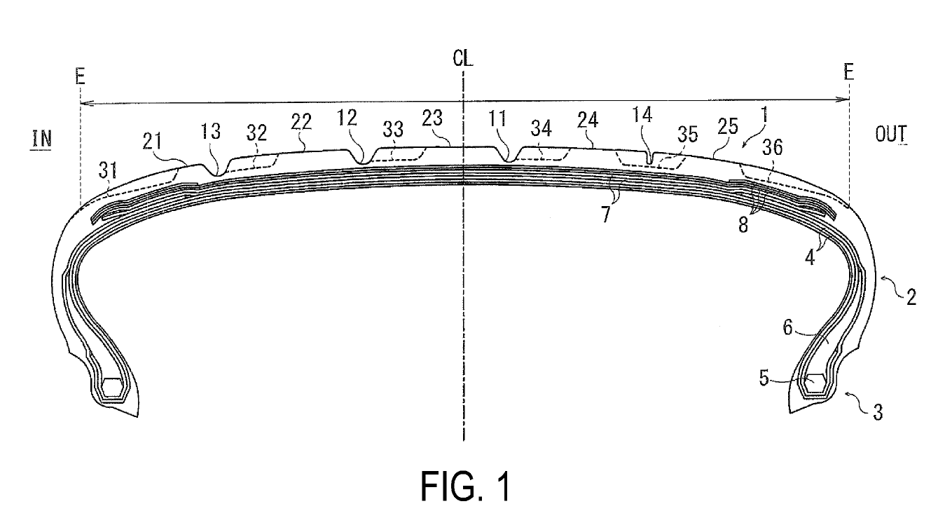

The reference sign CL in FIG. 1 denotes the tire equator. The pneumatic tire of an embodiment of the present technology is provided with an annular tread portion 1 extending in a tire circumferential direction, a pair of sidewall portions 2 disposed on opposite sides of the tread portion 1, and a pair of bead portions 3 disposed inward in a tire radial direction of the sidewall portions 2. A carcass layer 4 (two layers in FIG. 1) extends between the left-right pair of bead portions 3. The carcass layer 4 includes a plurality of reinforcing cords extending in a tire radial direction, and is folded back around a bead core 5 disposed in each bead portion 3 from a vehicle inner side to vehicle outer side. Additionally, a bead filler 6 is disposed on a periphery of each of the bead cores 5, and the bead filler 6 is enveloped by a main portion and the folded-back portion of the carcass layer 4. In the tread portion 1, a plurality of belt layers 7 (two layers in FIG. 1) are embedded on the outer circumferential side of the carcass layer 4. Each of the belt layers 7 includes a plurality of reinforcing cords inclined with respect to the tire circumferential direction, and the direction of the reinforcing cords of the different layers intersect each other. In the belt layers 7, the inclination angle of the reinforcing cords with respect to the tire circumferential direction ranges from, for example, 10° to 40°. A plurality of belt reinforcing layers 8 (three layers in FIG. 1) are disposed on the outer circumferential side of the belt layers 7. As illustrated in FIG. 1, the belt reinforcing layers 8 may include layers that only cover the end portions of the belt layers 7. The belt reinforcing layers 8 include organic fiber cords oriented in the tire circumferential direction. In the belt reinforcing layers 8, the angle of the organic fiber cords with respect to the tire circumferential direction is from 0° to 5°, for example.

The present technology may be applied to such a general pneumatic tire, however, the cross-sectional structure thereof is not limited to the basic structure described above.

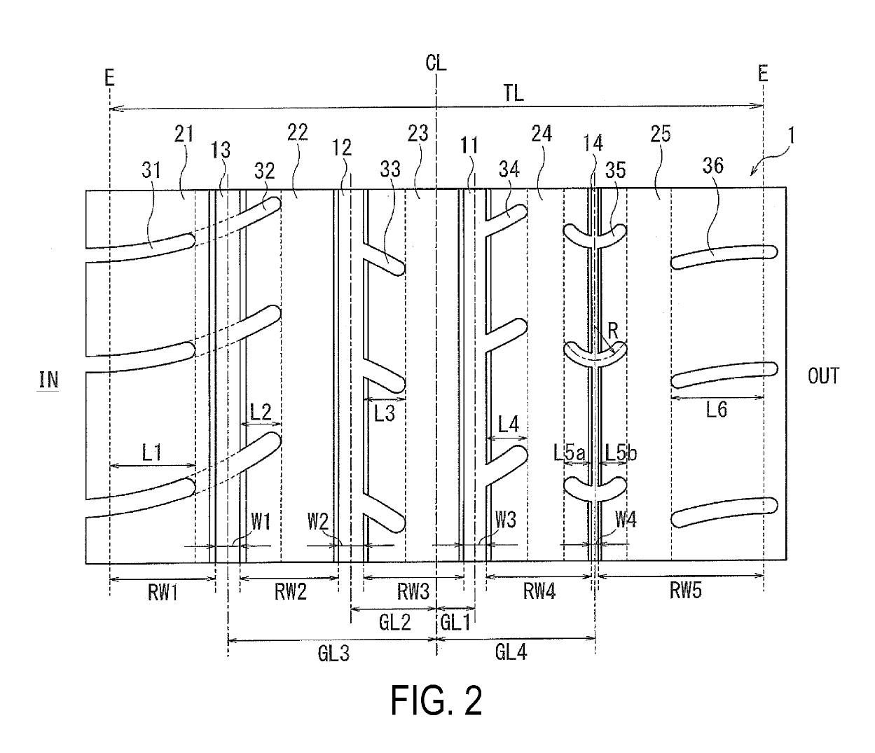

As illustrated in FIG. 2, the tread portion 1 is provided with three main grooves (a first main groove 11, a second main groove 12, and a third main groove 13) that extend in the tire circumferential direction. The first main groove 11 is located on the vehicle outer side of the tire equator CL in the tread portion 1. The second main groove 12 is located on the vehicle inner side of the tire equator CL in the tread portion 1. The third main groove 13 is located on the vehicle inner side of the second main groove 12 in the tread portion 1. In addition to these main grooves, one narrow groove 14 that extends in the tire circumferential direction is provided in the tread portion 1. The narrow groove 14 has a smaller groove width than those of the main grooves (the first main groove 11, the second main groove 12, and the third main groove 13), and is located on the vehicle outer side of the first main groove 11 in the tread portion 1.

Specifically, as illustrated in FIG. 2, the distance from the center position of the first main groove 11 to the tire equator CL is defined as GL1, the distance from the center position of the second main groove 12 to the tire equator CL is defined as GL2, the distance from the center position of the third main groove 13 to the tire equator CL is defined as GL3, and the distance from the center position of the narrow groove 14 to the tire equator CL is defined as GL4. The main grooves (the first main groove 11, the second main groove 12, and the third main groove 13) and the narrow groove 14 are arranged such that:

the distance GL1 is from 5% to 20% of a half-width TL/2 of a tire ground contact width TL;

the distance GL2 is from 20% to 35% of the half-width TL/2 of the tire ground contact width TL;

the distance GL3 is from 55% to 70% of the half-width TL/2 of the tire ground contact width TL;

the distance GL4 is from 40% to 60% of the half-width TL/2 of the tire ground contact width TL.

In the tread portion 1, five land portions (a first rib 21, a second rib 22, a third rib 23, a fourth rib 24, and a fifth rib 25) that extend in the circumferential direction are defined by the main grooves (the first main groove 11, the second main groove 12, and the third main groove 13) and the narrow groove 14. The first rib 21 is disposed on the vehicle inner side of the third main groove 13. The second rib 22 is disposed between the third main groove 13 and the second main groove 12. The third rib 23 is disposed between the second main groove 12 and the first main groove 11. The fourth rib 24 is disposed between the first main groove 11 and the narrow groove 14. The fifth rib 15 is disposed on the vehicle outer side of the narrow groove 14. Lug grooves described below are provided in these land portions, however, the land portions extend continuously around the entire circumference in the tire circumferential direction without being divided by the lug grooves.

Each of the ribs (the first rib 21, the second rib 22, the third rib 23, the fourth rib 24, and the fifth rib 25) are provided with a plurality of lug grooves (a first lug groove 31, a second lug groove 32, a third lug groove 33, a fourth lug groove 34, a fifth lug groove 35, and a sixth lug groove 36) that extend in the tire width direction. The first lug groove 31 includes one end that reaches the ground contact edge E on the vehicle inner side and another end terminating within the first rib 21 without communicating with the third main groove 13. The second lug groove 32 includes one end communicating with the third main groove 13 and another end terminating within the second rib 22. The third lug groove 33 includes one end communicating with the second main groove 12 and another end terminating within the third rib 23. The fourth lug groove 34 includes one end communicating with the first main groove 11 and another end terminating within the fourth rib 24. The fifth lug groove 35 intersects the narrow groove 14 and includes one end terminating within the fourth rib 24 and another end terminating within the fifth rib 25. The sixth lug groove 36 includes one end that reaches the ground contact edge E on the vehicle outer side and the other end terminating within the fifth rib 25 without communicating with the narrow groove 14.

According to an embodiment of the present technology, by disposing the main grooves (the first main groove 11, the second main groove 12, and the third main groove 13) at a location near the tire equator CL or on the vehicle inner side of the tire equator CL, efficient drainage properties can be provided. Additionally, by disposing the narrow groove 14 with a smaller groove width than those of the main grooves (the first main groove 11, the second main groove 12, and the third main groove 13) at a location furthest to the vehicle outer side, tread rigidity can be increased while ensuring sufficient drainage performance in the region. As a result, steering stability performance can be improved while maintaining drainage performance and wet performance. Furthermore, the lug grooves (the first lug groove 31, the second lug groove 32, the third lug groove 33, the fourth lug groove 34, the fifth lug groove 35, and the sixth lug groove 36) include an end portion on one side that terminates within the corresponds rib (the first rib 21, the second rib 22, the third rib 23, the fourth rib 24, and the fifth rib 25), and the land portions defined by the main grooves (the first main groove 11, the second main groove 12, and the third main groove 13) and the narrow groove 14 are ribs that are continuous in the tire circumferential direction. This configuration also allows tread rigidity to be increased and steering stability performance to be improved. By specifying the terminating positions of the lug grooves as described above and not just providing ribs that are continuous in the tire circumferential direction, uneven wear can be suppressed. In such a manner, steering stability performance can be improved while maintaining excellent drainage performance and wet performance. Furthermore, excellent uneven wear resistance performance can be obtained.

If the distance GL1 is less than 5% of the half-width TL/2 of the tire ground contact width TL, the first main groove becomes practically aligned with the tire equator CL, and sufficient width of the third rib 23 cannot be ensured. As a result, tread rigidity becomes difficult to increase in a compatible manner. If the distance GL1 is greater than 20% of the half-width TL/2 of the tire ground contact width TL, the first main groove 11 becomes located too far from the tire equator CL, and thus efficient drainage becomes difficult to achieve. If the distance GL2 is less than 20% of the half-width TL/2 of the tire ground contact width TL, sufficient width of the third rib 23 cannot be ensured, and thus tread rigidity becomes difficult to achieve in a compatible manner. If the distance GL2 is greater than 35% of the half-width TL/2 of the tire ground contact width TL, the second main groove 12 becomes located too far from the tire equator CL, and thus groove area near the tire equator CL decreases. As a result, efficient drainage becomes difficult to achieve. If the distance GL3 is less than 55% of the half-width TL/2 of the tire ground contact width TL, sufficient width of the second rib 22 cannot be ensured, and thus tread rigidity becomes difficult to achieve in a compatible manner. If the distance GL3 is greater than 70% of the half-width TL/2 of the tire ground contact width TL, the third main groove 13 becomes located too far outward in the tire width direction, and thus efficient drainage becomes difficult to achieve. If the distance GL4 is less than 40% of the half-width TL/2 of the tire ground contact width TL, the width of the fifth rib 25 becomes excessive, and thus good drainage in this region becomes difficult to achieve. If the distance GL4 is greater than 60% of the half-width TL/2 of the tire ground contact width TL, the width of the fourth rib 24 becomes excessive, and thus efficient drainage becomes difficult to achieve.

Additionally, if the lug grooves (the first lug groove 31, the second lug groove 32, the third lug groove 33, the fourth lug groove 34, the fifth lug groove 35, and the sixth lug groove 36) do not terminate within the corresponding ribs (the first rib 21, the second rib 22, the third rib 23, the fourth rib 24, and the fifth rib 25) at at least one end so that the ribs are divided, land portion rigidity decreases, and thus excellent steering stability performance becomes difficult to achieve.

The groove widths (W1, W2, W3 in FIG. 2) of the main grooves (the first main groove 11, the second main groove 12, and the third main groove 13) are preferably 8 mm or greater to obtain sufficient drainage performance. However, if the groove width is excessive, the groove portion becomes prone to buckling due to lateral forces when cornering. Thus the groove width W1 is preferably 16 mm or less. The groove widths of the main grooves (the first main groove 11, the second main groove 12, and the third main groove 13) are more preferably from 10 mm to 14 mm. The groove depths of the main groove (the first main groove 11, the second main groove 12, and the third main groove 13) are preferably 5 mm or greater to obtain sufficient drainage performance. However, if the groove depth is excessive, tread rigidity decreases and sufficiently improving steering stability becomes problematic. Thus the groove depth is preferably 7 mm or less. The groove depths of the main grooves (the first main groove 11, the second main groove 12, and the third main groove 13) are more preferably from 5.5 mm to 7.5 mm.

The groove width of the narrow groove 14 is less than those of the main grooves (the first main groove 11, the second main groove 12, and the third main groove 13) and the groove width W4 of the narrow groove 14 is preferably from 10% to 60% of the groove width W1 of the first main groove 11. Setting the groove width W4 of the narrow groove 14 in such a manner relative to the groove width W1 of the first main groove 11 is advantageous in achieving good wet performance and steering stability performance in a compatible manner. If the groove width W4 of the narrow groove 14 is less than 10% of the groove width W1 of the first main groove 11, the narrow groove 14 makes it difficult to achieve sufficient drainage performance. If the groove width W4 of the narrow groove 14 is greater than 60% of the groove width W1 of the first main groove 11, rigidity of the fourth rib 24 and the fifth rib 25 becomes difficult to be maintained at a high degree, and thus steering stability performance becomes difficult to improve.

The groove depth of the narrow groove 14 is not particularly limited, but is preferably less than the groove depth of the main grooves (the first main groove 11, the second main groove 12, and the third main groove 13). The groove depth is particularly preferably from 60% to 80% of the groove depth of the first main groove. Setting the groove depth of the narrow groove 14 in such a manner relative to the groove depth of the first main groove 11 is advantageous in achieving good wet performance and steering stability performance in a compatible manner. If the groove depth of the narrow groove 14 is less than 60% of the groove depth of the first main groove 11, the narrow groove 14 makes it difficult to achieve sufficient drainage performance. If the groove depth of the narrow groove 14 is greater than 80% of the groove depth of the first main groove 11, rigidity of the fourth rib 24 and the fifth rib 25 becomes difficult to be maintained at a high degree, and thus steering stability performance becomes difficult to improve.

Specifically, the groove width W4 of the narrow groove 14 is preferably from 1 mm to 6 mm, and the groove depth is preferably from 3 mm to 6 mm. If the groove width W4 of the narrow groove 14 is less than 1 mm, sufficient drainage performance becomes difficult to achieve. If the groove width W4 of the narrow groove 14 is greater than 6 mm, tread rigidity decreases, and thus steering stability becomes difficult to improve. If the groove depth of the narrow groove 14 is less than 3 mm, sufficient drainage performance becomes difficult to achieve. If the groove depth of the narrow groove 14 is greater than 6 mm, tread rigidity decreases, and thus steering stability becomes difficult to be improved.

The widths (RW1, RW2, RW3, RW4, RW5 in FIG. 2) of the ribs (the first rib 21, the second rib 22, the third rib 23, the fourth rib 24, and the fifth rib 25) are determined by the arrangement (the distances GL1 to GL4) of the main grooves (the first main groove 11, the second main groove 12, and the third main groove 13) and the narrow groove 14 in a predetermined range. However, the width RW3 of the third rib 13 is preferably from 80% to 120% of the width RW2 of the second rib 12. Setting the width of the second rib 12 and the third rib 13 to be equal is advantageous in obtaining sufficient tread rigidity and thus improving steering stability performance.

The first lug groove 31 and the second lug groove 32 are preferably arranged so that the second lug groove 32 is disposed on an extension line of the first lug groove 31, as illustrated by the dotted line in FIG. 2. By arranging the first lug groove 31 and the second lug groove 32 in this manner, excellent drainage properties can be achieved.

Additionally, the second lug groove 32 and the third lug groove 33 are preferably arranged so that the opening portions are offset in the tire circumferential direction. In a similar manner, the third lug groove 33 and the fourth lug groove 34 are preferably arranged so that the opening portions are offset in the tire circumferential direction. By not aligning the opening portions of the lug grooves (the second lug groove 32, the third lug groove 33, and the fourth lug groove 34) disposed in adjacent ribs (the second rib 22 and the third rib 23, the third rib 23 and the fourth rib 24), the balance of tread rigidity can be made uniform, and thus steering stability performance and uneven wear resistance performance can be effectively increased. In particular, as illustrated in FIG. 2, the second lug grooves 32 and the third lug grooves 33 are preferably alternately disposed in the tire circumferential direction, and the third lug grooves 33 and the fourth lug grooves 34 are preferably alternately disposed in the tire circumferential direction.

As illustrated in FIG. 2, the lug grooves (the first lug groove 31, the second lug groove 32, the third lug groove 33, the fourth lug groove 34, the fifth lug groove 35, and the sixth lug groove 36) are preferably inclined with respect to the tire width direction. Note that in the embodiment illustrated in FIG. 2, the fifth lug groove 35 has a curved shape that intersects with the narrow groove 14. However, by independently viewing the end proximal to the fourth rib 24 and the other end proximal to the fifth rib 25, one can appreciate that the groove is inclined with respect to the tire width direction. In embodiments in which the lug grooves are inclined as such, the third lug groove 33 and the second lug groove 32 are preferably inclined in opposite direction with respect to the tire width direction, and the fourth lug groove 34 and the third lug groove 33 are preferably inclined in opposite direction with respect to the tire width direction. By varying the inclination direction of the second lug groove 32, the third lug groove 33, and the fourth lug groove 34, the balance of tread rigidity can be made uniform, and thus steering stability performance and uneven wear resistance performance can be effectively increased.

The lug grooves (the first lug groove 31, the second lug groove 32, the third lug groove 33, the fourth lug groove 34, the fifth lug groove 35, and the sixth lug groove 36) terminate within the corresponding rib without dividing the ribs (the first rib 21, the second rib 22, the third rib 23, the fourth rib 24, and the fifth rib 25) as described above. More preferably, the terminating position of the lug grooves (the length of the lug grooves with respect to the width of the ribs) are preferably set as described below. A length L1 of the first lug groove 31 is preferably from 80% to 90% of the width RW1 of the first rib 21; a length L2 of the second lug groove 32 is preferably from 30% to 50% of the width RW2 of the second rib 22; a length L3 of the third lug groove 33 is preferably from 30% to 50% of the width RW3 of the third rib 23; a length L4 of the fourth lug groove 34 is preferably from 30% to 50% of the width RW4 of the fourth rib 24; and a length L6 of the sixth lug groove 36 is preferably from 50% to 80% of the width RW5 of the fifth rib 25. In embodiments with the lengths set as so, the third lug groove 33 preferably terminates in the region of the third rib 23 on the vehicle inner side without reaching the tire equator CL. The fifth lug groove 35 terminates within the fourth rib 24 at one end and terminates within the fifth rib 25 at the other end. The length on one side (the length in the tire width direction from the wall of the narrow groove 14 proximal to the tire equator CL to the terminating position within the fourth rib 24) is defined as L5a, and the length on the other side (length in the tire width direction from the wall of the narrow groove 14 located outward in the tire width direction to the terminating position within the fifth rib 25) is defined as L5b. The length L5a is preferably from 20% to 30% of the width RW4 of the fourth rib 24, and the length L5b is preferably from 10% to 20% of the width RW5 of the fifth rib 25. Note that the width RW1 of the first rib 21 and the width RW5 of the fifth rib 25 are the length from the third main groove 13/narrow groove 14 to the corresponding ground contact edge E, as illustrated in FIG. 2.

Note that the groove depths of the lug grooves (the first lug groove 31, the second lug groove 32, the third lug groove 33, the fourth lug groove 34, the fifth lug groove 35, and the sixth lug groove 36) are not particularly limited, but the groove depths are preferably less than the groove depths of the main grooves (the first main groove 11, the second main groove 12, and the third main groove 13) and greater than the groove depth of the narrow groove 14. More preferably, the groove depths of the lug grooves are preferably 80% or greater of the groove depth of the narrow groove 14, and 100% or less of the groove depth of the first main groove. Accordingly, as illustrated in FIG. 1, the groove depth of the fifth lug groove 35 may be greater than the groove depth of the narrow groove 14.

The fifth lug groove 35, as illustrated above, intersects the narrow groove 14 and includes an end that terminates within the fourth rib 24 and another end that terminates within the fifth rib 25. However, as illustrated in FIG. 2, the end proximal to the fourth rib 24 and the end proximal to the fifth rib 25 are both preferably located to one side in the tire circumferential direction of the point where the fifth lug groove 35 intersects the narrow groove 14. Examples of such a shape include a V-shape that bends at the point of intersection with the narrow groove 14, and a curved shape that curves to one side in the tire circumferential direction as illustrated in FIG. 2. With this shape, the force applied to the lug grooves, which are susceptible to damage when braking/driving or when turning, is distributed, and it is thus possible to suppress uneven wear. The curved shape illustrated in FIG. 2 is particularly preferable in terms of enabling enhancements to pass-by noise.

In embodiments in which the fifth lug groove 35 has the curved shape illustrated in FIG. 2, the radius of curvature R of the curved portion of the fifth lug groove 35 is preferably from 8 mm to 50 mm. The fifth lug groove having such a curved shape is advantageous in enhancing uneven wear resistance performance and noise performance. If the radius of curvature R is less than 8 mm, the fifth lug groove 35 cannot be ensured sufficient length in the tire width direction, and thus no significant effect can be obtained from disposing the fifth lug groove 35. If the radius of curvature R is greater than 50 mm, the shape of the fifth lug groove 35 is roughly rectilinear in the tire width direction. This makes achieving sufficient effects from the curved fifth lug groove 35 difficult. Note that the radius of curvature R of the fifth lug groove 35, as illustrated in FIG. 2, is a value measured using the center line (dot-dash line) of the fifth lug groove 35 as a reference.

In embodiments configured as described above, the groove area ratio of the region of the tread portion 1 on the vehicle outer side of the tire equator CL (the groove area ratio on the vehicle outer side) is preferably relatively less than the groove area ratio of the region of the tread portion 1 on the vehicle inner side of the tire equator CL (the groove area ratio on the vehicle inner side). In particular, the groove area ratio on the vehicle outer side preferably ranges from 8% to 25%, and the groove area ratio on the vehicle inner side preferably ranges from 22% to 40%. Setting the groove area ratios as such is advantageous in achieving good drainage performance and steering stability performance in a compatible manner.

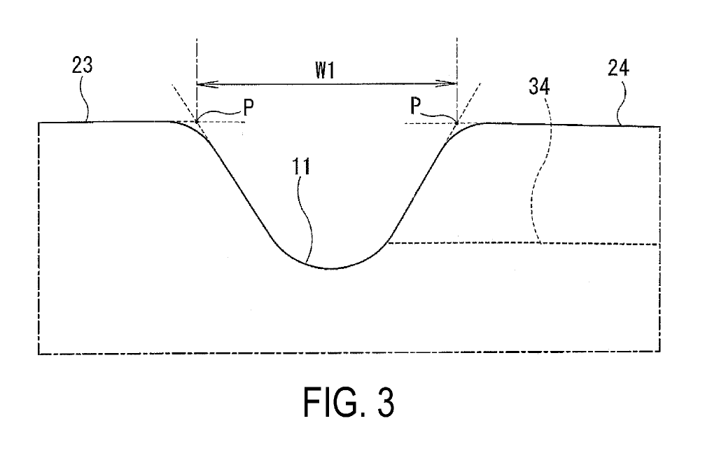

The grooves that extend in the tire circumferential direction (in other words, the first main groove 11, the second main groove 12, the third main groove 13, and the narrow groove 14) are preferably chamfered or radiused as illustrated in the enlarged view of FIG. 3 (note that FIG. 3 is an enlarged view of the first main groove 11, however this also applies to the other grooves). This enables sufficient groove area (groove volume) of the grooves to be ensured in the initial period of wear without increasing the groove width. As a result, excellent drainage performance can be achieved while ensuring tread rigidity. A portion from 1 mm to 2 mm from the corner portion where the groove wall and the tread surface meet is preferably removed. In particular, the edge is preferably radiused. Note that in embodiments in which the grooves are chamfered or radiused as such, as illustrated in FIG. 3, the groove width and the groove depth of the main grooves (the first main groove 11, the second main groove 12, the third main groove 13) and the narrow groove 14, the length of the lug groove, the width of the rib, and such dimensions are measured using the point of intersection P of an extension line of the groove wall and an extension line of the tread surface as a reference.

### EXAMPLES

Twenty-nine types of pneumatic tires including Conventional Example 1, Comparative Example 1, and Examples 1 to 27 were manufactured. The pneumatic tires had a tire size of 285/35ZR20 and had the reinforcement structure illustrated in FIG. 1. The configurations of the pneumatic tires were set as indicated in Tables 1 to 5 for the following:

base tread pattern,

distances of the first main groove to the third main groove and the narrow groove from the tire equator (proportion of the half-width TL of the ground contact width),

length in the tire width direction of the first lug groove to the fifth lug groove (proportion of the rib width), groove width of the first main groove to the third main groove and the narrow groove (ratio of the narrow groove to the first main groove is also indicated),

rib width of the first rib to the fifth rib (proportion of the ground contact width TL, the ratio of the rib width of the third rib to the rib width of the second rib is also indicated),

positional relationship between the opening portions of the second lug groove and the third lug groove, and between the opening portions of the third lug groove and the fourth lug groove (position of opening portion),

relationship between the inclination directions of the second lug groove and the third lug groove, and between the inclination directions of the third lug groove and the fourth lug groove (inclination angle),

groove area ratio in the vehicle outer side region and the vehicle inner side region,

chamfered/radiused first main groove to third main grooves and narrow groove.

Note that common to all examples, the depth of the first main groove to the third main groove was 5.5 mm, the depth of the narrow groove was 4.5 mm, and the depth of the first lug groove to the sixth lug groove was 5.5 mm.

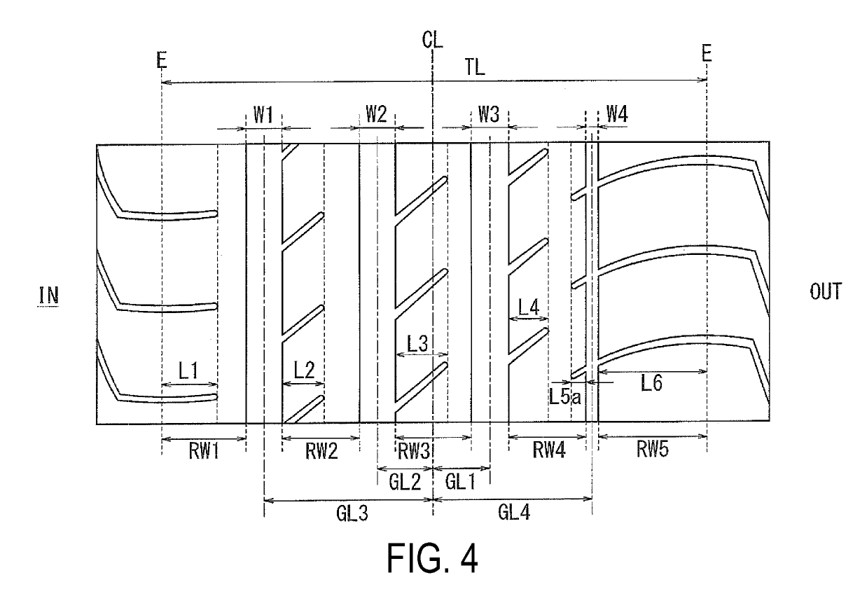

Conventional Example 1 had the tread pattern illustrated in FIG. 4. This tread pattern is different from that of Comparative Example 1 and Examples 1 to 27. However, the main groove on the vehicle outer side of the tire equator corresponds to the first main groove, the main groove on the vehicle inner side of the tire equator corresponds to the second main groove, the main groove on the vehicle inner side of the second main groove corresponds to the third main groove, and the groove on the vehicle outer side of the first main groove corresponds to the narrow groove. The distances from the center position to the tire equator of these grooves correspond to GL1 to GL4. Additionally, the groove widths of these grooves correspond to W1 to W4. In a similar manner, the land portion on the vehicle inner side of the third main groove corresponds to the first rib, the land portion between the third main groove and the second main groove corresponds to the second rib, the land portion between the second main groove and the first main groove corresponds to the third rib, the land portion between the first main groove and the narrow groove corresponds to the fourth rib, and the land portion on the vehicle outer side of the narrow groove corresponds to the fifth rib. The widths of these portions correspond to RW1 to RW5. Furthermore, the lug groove formed in the first rib corresponds to the first lug groove, the lug groove formed in the second rib corresponds to the second lug groove, the lug groove formed in the third lug groove corresponds to the third lug groove, the lug groove formed in the fourth lug groove that communicates with the first main groove corresponds to the fourth lug groove. The lengths of these lug grooves correspond to L1 to L4. The shape of the lug groove provided near the narrow groove and in the fifth rib as illustrated in FIG. 4, is significantly different from the shape of the fifth and sixth lug groove in FIG. 2. However, for the sake of convenience, the lug groove including one end that communicates with the narrow groove and another end that terminates within the fourth rib corresponds to the fifth lug groove (the length corresponds to L5a, L5b is non-existent), and the lug groove disposed in the fifth rib and includes one end that reaches the ground contact edge on the vehicle outer side and another end that communicates with the narrow groove corresponds to the sixth lug groove (the length corresponds to L6).

In Comparative Example 1, the base tread pattern is based on that illustrated in FIG. 2. However, the first lug groove, the second lug groove, the third lug groove, the fourth lug groove, and the sixth lug groove do not terminate within the corresponding rib, with both ends reaching the main grooves, the narrow groove, or the ground contact edge. In other words, the ribs are divided as blocks. Accordingly, in Table 1, the lengths in the tire width direction of the first lug groove to the fourth lug groove and the sixth lug groove (proportion of the rib width) are 100%.

For “position of opening portion” in Table 1, if the opening portions of the second lug groove and the third lug groove, and the opening portions of the third lug groove and the fourth lug groove are aligned in the tire circumferential direction, “aligned” is indicated, and if they are offset in the tire circumferential direction, “not aligned” is indicated.

These 30 types of pneumatic tire were evaluated using the methods described below for dry performance by measuring steering stability performance and travel time on dry road surfaces, wet performance by measuring steering stability performance and hydroplaning resistance performance on wet road surfaces, uneven wear resistance performance, and noise performance. The results are shown in Tables 1 and 2.

### Dry Performance (Steering Stability Performance)

For each tire, the tires were assembled on a wheel with a rim size of 20×10.5 JJ, inflate to an air pressure of 220 kPa, and mounted on a test vehicle with an engine displacement of 3.8 L. The vehicle was test driven by a test driver on a dry road surface circuit course, and the steering stability performance was measured by sensory evaluation. The evaluation results are scored out of 10 with Conventional Example 1 being given a score of 5 (reference). Higher scores indicate superior dry performance (steering stability performance).

### Dry Performance (Travel Time)

Each tire was assembled on a wheel with a rim size of 20×10.5 JJ, inflated to an air pressure of 220 kPa, and mounted on a test vehicle with an engine displacement of 3.8 L. The vehicle was driven on a dry road surface circuit course (one lap equaling approximately 4500 m) for seven laps, and the travel time (sec) for one lap was measured for each lap. The fastest travel time measured for one lap was taken as the travel time. The evaluation results were expressed as index values using the inverse value as the measurement value, and Conventional Example 1 being defined as 100. Larger index values indicate less driving time. Note that an index value of 98 or greater means that the conventional level is maintained.

### Wet Performance (Steering Stability Performance)

Each tire was assembled on a wheel with a rim size of 20×10.5 JJ, inflated to an air pressure of 220 kPa, and mounted on a test vehicle with an engine displacement of 3.8 L. The vehicle was test driven by a test driver on a circuit course with water on the surface, and the steering stability performance was measured by sensory evaluation. The evaluation results are scored out of 10 with Conventional Example 1 being given a score of 5 (reference). Higher scores indicate superior wet performance (steering stability).

### Wet Performance (Hydroplaning Resistance Performance)

Each tire was assembled on a wheel with a rim size of 20×10.5 JJ, inflated to an air pressure of 220 kPa, and mounted on a test vehicle with an engine displacement of 3.8 L. The vehicle was test driven into a pool of water with a depth of 10±1 mm on a straight portion of the road. The speed at which the vehicle was driven into the pool was gradually increased. The speed at which hydroplaning occurred was measured as the limiting speed. Evaluation results were expressed as index values with Conventional Example 1 being defined as 100. Larger index values indicate superior hydroplaning resistance performance. Note that an index value of 98 or greater means that the conventional level is maintained.

### Wear Resistance Performance

Each tire was assembled on a wheel with a rim size of 20×10.5 JJ, inflated to an air pressure of 220 kPa, and mounted on a test vehicle with an engine displacement of 3.8 L. The vehicle was test driven by a test driver on a circuit course continuously for 50 km, after which the degree of uneven wear in the tread portion was inspected.

Uneven wear resistance performance was evaluated by scoring the degree of uneven wear out of 10 (10: excellent, 9-8: good, 7-6: fair, 5 or less: unsatisfactory). Larger index values indicate superior uneven wear resistance performance.

### Noise Performance

Each tire was assembled on a wheel with a rim size of 20×10.5 JJ, inflated to an air pressure of 220 kPa, and mounted on a test vehicle with an engine displacement of 3.8 L. The vehicle was driven on a test road surface for measuring external noise in accordance with the ISO, and the pass-by noise when traveling at 80 km/h was measured. The evaluation results were expressed as index values using the inverse value as the measurement value, and Conventional Example 1 being defined as 100. Larger index values indicate lower pass-by noise and superior noise performance. Note that an index value of 98 or greater means that the conventional level is maintained.

TABLE 1

| | | | Conventional | Comparative | | | | |
|---|---|---|---|---|---|---|---|---|
| | | | Example 1 | Example 1 | Example 1 | Example 2 | Example 3 | Example 4 |
| Base tread pattern | | | FIG. 4 | FIG. 2 | FIG. 2 | FIG. 2 | FIG. 2 | FIG. 2 |
| Distance | GL1/(TL/2) | % | 20 | 12 | 12 | 5 | 20 | 12 |
| | GL2/(TL/2) | % | 20 | 26 | 26 | 26 | 26 | 20 |
| | GL3/(TL/2) | % | 55 | 65 | 65 | 65 | 65 | 65 |
| | GL4/(TL/2) | % | 45 | 50 | 50 | 50 | 50 | 50 |
| Length of | L1/RW1 | % | 80 | 100 | 80 | 80 | 80 | 80 |
| lug | L2/RW2 | % | 50 | 100 | 40 | 40 | 40 | 40 |
| groove | L3/RW3 | % | 45 | 100 | 40 | 40 | 40 | 40 |
| | L4/RW4 | % | 25 | 100 | 40 | 40 | 40 | 40 |
| | L5a/RW4 | % | 25 | 20 | 20 | 20 | 20 | 20 |
| | L5b/RW5 | % | — | 20 | 20 | 20 | 20 | 20 |
| | L6/RW5 | % | 100 | 100 | 60 | 60 | 60 | 60 |
| Groove | W1 | mm | 15 | 10 | 10 | 10 | 10 | 10 |
| width | W2 | mm | 15 | 10 | 10 | 10 | 10 | 10 |
| | W3 | mm | 20 | 10 | 10 | 10 | 10 | 10 |
| | W4 | mm | 4 | 2 | 2 | 2 | 2 | 2 |
| | W4/W1 | % | 30 | 20 | 20 | 20 | 20 | 20 |
| Rib width | RW1/TL | % | 20 | 18 | 18 | 18 | 18 | 18 |
| | RW2/TL | % | 10 | 31 | 31 | 31 | 31 | 28 |
| | RW3/TL | % | 15 | 31 | 31 | 35 | 27 | 34 |
| | RW3/RW2 | % | 120 | 102 | 102 | 113 | 89 | 124 |
| | RW4/TL | % | 15 | 31 | 31 | 28 | 35 | 31 |
| | RW5/TL | % | 20 | 25 | 25 | 25 | 25 | 25 |
| Position of opening portion | | | Not aligned | Not aligned | Not | Not | Not | Not |
| (second and third lug groove) | | | | | aligned | aligned | aligned | aligned |
| Position of opening portion | | | Not aligned | Not aligned | Not | Not | Not | Not |
| (third and fourth lug groove) | | | | | aligned | aligned | aligned | aligned |
| Inclination direction | | | Same | Opposite | Opposite | Opposite | Opposite | Opposite |
| (second and third lug groove) | | | | | | | | |
| Inclination direction | | | Same | Opposite | Opposite | Opposite | Opposite | Opposite |
| (third and fourth lug groove) | | | | | | | | |
| Shape of fifth lug groove | | | — | Curved | Curved | Curved | Curved | Curved |
| Radius of curvature R of fifth | | mm | — | 10 | 10 | 10 | 10 | 10 |
| lug groove | | | | | | | | |
| Groove area ratio | | % | 28 | 15 | 15 | 15 | 15 | 15 |
| (vehicle outer side) | | | | | | | | |
| Groove area ratio | | % | 34 | 31 | 31 | 31 | 31 | 31 |
| (vehicle inner side) | | | | | | | | |
| Chamfered/Radiused | | | Yes | Yes | Yes | Yes | Yes | Yes |
| Dry | Steering | | 5 | 4 | 8 | 8 | 8 | 8 |
| performance | stability | | | | | | | |
| | performance | | | | | | | |
| | Travel time | Index | 100 | 98 | 105 | 105 | 105 | 105 |
| | | value | | | | | | |
| Wet | Steering | | 5 | 8 | 8 | 8 | 8 | 8 |
| performance | stability | | | | | | | |
| | performance | | | | | | | |
| | Hydroplaning | Index | 100 | 105 | 104 | 104 | 104 | 104 |
| | resistance | value | | | | | | |
| | performance | | | | | | | |

| Uneven wear resistance | | 7 | 5 | 9 | 9 | 9 | 9 |
|---|---|---|---|---|---|---|---|
| performance | | | | | | | |
| Noise performance | Index | 100 | 102 | 102 | 102 | 102 | 102 |
| | value | | | | | | |

TABLE 2

| | | | | | | | | Example |
|---|---|---|---|---|---|---|---|---|
| | | | Example 5 | Example 6 | Example 7 | Example 8 | Example 9 | 10 |
| Base tread pattern | | | FIG. 2 | FIG. 2 | FIG. 2 | FIG. 2 | FIG. 2 | FIG. 2 |
| Distance | GL1/(TL/2) | % | 12 | 12 | 12 | 12 | 12 | 12 |
| | GL2/(TL/2) | % | 35 | 26 | 26 | 26 | 26 | 26 |
| | GL3/(TL/2) | % | 65 | 55 | 70 | 65 | 65 | 65 |
| | GL4/(TL/2) | % | 50 | 50 | 50 | 40 | 60 | 50 |
| Length | L1/RW1 | % | 80 | 80 | 80 | 80 | 80 | 80 |
| of lug | L2/RW2 | % | 40 | 40 | 40 | 40 | 40 | 40 |
| groove | L3/RW3 | % | 40 | 40 | 40 | 40 | 40 | 40 |
| | L4/RW4 | % | 40 | 40 | 40 | 40 | 40 | 40 |
| | L5a/RW4 | % | 20 | 20 | 20 | 20 | 20 | 20 |
| | L5b/RW5 | % | 20 | 20 | 20 | 20 | 20 | 20 |
| | L6/RW5 | % | 60 | 60 | 60 | 60 | 60 | 60 |
| Groove | W1 | mm | 10 | 10 | 10 | 10 | 10 | 8 |
| width | W2 | mm | 10 | 10 | 10 | 10 | 10 | 8 |
| | W3 | mm | 10 | 10 | 10 | 10 | 10 | 8 |
| | W4 | mm | 2 | 2 | 2 | 2 | 2 | 2 |
| | W4/W1 | % | 20 | 20 | 20 | 20 | 20 | 25 |
| Rib | RW1/TL | % | 18 | 23 | 15 | 18 | 18 | 18 |
| width | RW2/TL | % | 35 | 36 | 28 | 31 | 31 | 31 |
| | RW3/TL | % | 27 | 31 | 31 | 31 | 31 | 31 |
| | RW3/RW2 | % | 76 | 87 | 111 | 102 | 102 | 102 |
| | RW4/TL | % | 31 | 31 | 31 | 36 | 26 | 31 |
| | RW5/TL | % | 25 | 25 | 25 | 30 | 20 | 25 |
| Position of opening portion | | | Not | Not | Not | Not | Not | Not |
| (second and third lug groove) | | | aligned | aligned | aligned | aligned | aligned | aligned |
| Position of opening portion | | | Not | Not | Not | Not | Not | Not |
| (third and fourth lug groove) | | | aligned | aligned | aligned | aligned | aligned | aligned |
| Inclination direction | | | Opposite | Opposite | Opposite | Opposite | Opposite | Opposite |
| (second and third lug groove) | | | | | | | | |
| Inclination direction | | | Opposite | Opposite | Opposite | Opposite | Opposite | Opposite |
| (third and fourth lug groove) | | | | | | | | |
| Shape of fifth lug groove | | | Curved | Curved | Curved | Curved | Curved | Curved |
| Radius of curvature R of fifth | | mm | 10 | 10 | 10 | 10 | 10 | 10 |
| lug groove | | | | | | | | |
| Groove area ratio | | % | 15 | 15 | 15 | 15 | 15 | 15 |
| (vehicle outer side) | | | | | | | | |
| Groove area ratio | | % | 31 | 31 | 31 | 31 | 31 | 31 |
| (vehicle inner side) | | | | | | | | |
| Chamfered/Radiused | | | Yes | Yes | Yes | Yes | Yes | Yes |
| Dry | Steering stability | | 8 | 8 | 8 | 8 | 8 | 9 |
| performance | performance | | | | | | | |
| | Travel time | Index | 105 | 105 | 105 | 105 | 105 | 107 |
| | | value | | | | | | |
| Wet | Steering stability | | 8 | 8 | 8 | 8 | 8 | 6 |
| performance | performance | | | | | | | |
| | Hydroplaning | Index | 104 | 104 | 104 | 104 | 104 | 98 |
| | resistance | value | | | | | | |
| | performance | | | | | | | |

| Uneven wear resistance | | 9 | 9 | 9 | 9 | 9 | 8 |
|---|---|---|---|---|---|---|---|
| performance | | | | | | | |
| Noise | Index | 102 | 102 | 102 | 102 | 102 | 103 |
| performance | value | | | | | | |

TABLE 3

| | | | Example | Example | Example | Example | Example | Example |
|---|---|---|---|---|---|---|---|---|
| | | | 11 | 12 | 13 | 14 | 15 | 16 |
| Base tread pattern | | | FIG. 2 | FIG. 2 | FIG. 2 | FIG. 2 | FIG. 2 | FIG. 2 |
| Distance | GL1/(TL/2) | % | 12 | 12 | 12 | 12 | 12 | 12 |
| | GL2/(TL/2) | % | 26 | 26 | 26 | 26 | 26 | 26 |
| | GL3/(TL/2) | % | 65 | 65 | 65 | 65 | 65 | 65 |
| | GL4/(TL/2) | % | 50 | 50 | 50 | 50 | 50 | 50 |
| Length of | L1/RW1 | % | 80 | 80 | 80 | 80 | 80 | 80 |
| lug | L2/RW2 | % | 40 | 40 | 40 | 40 | 40 | 40 |
| groove | L3/RW3 | % | 40 | 40 | 40 | 40 | 40 | 40 |
| | L4/RW4 | % | 40 | 40 | 40 | 40 | 40 | 40 |
| | L5a/RW4 | % | 20 | 20 | 20 | 20 | 20 | 20 |
| | L5b/RW5 | % | 20 | 20 | 20 | 20 | 20 | 20 |
| | L6/RW5 | % | 60 | 60 | 60 | 60 | 60 | 60 |
| Groove | W1 | mm | 14 | 16 | 10 | 10 | 10 | 10 |
| width | W2 | mm | 14 | 16 | 10 | 10 | 10 | 10 |
| | W3 | mm | 14 | 16 | 10 | 10 | 10 | 10 |
| | W4 | mm | 2 | 2 | 0.5 | 1 | 6 | 7 |
| | W4/W1 | % | 14.3 | 12.5 | 5 | 10 | 60 | 70 |
| Rib width | RW1/TL | % | 18 | 18 | 18 | 18 | 18 | 18 |
| | RW2/TL | % | 31 | 31 | 31 | 31 | 31 | 31 |
| | RW3/TL | % | 31 | 31 | 31 | 31 | 31 | 31 |
| | RW3/RW2 | % | 102 | 102 | 102 | 102 | 102 | 102 |
| | RW4/TL | % | 31 | 31 | 31 | 31 | 31 | 31 |
| | RW5/TL | % | 25 | 25 | 25 | 25 | 25 | 25 |
| Position of opening portion | | | Not | Not | Not | Not | Not | Not |
| (second and third lug groove) | | | aligned | aligned | aligned | aligned | aligned | aligned |
| Position of opening portion | | | Not | Not | Not | Not | Not | Not |
| (third and fourth lug groove) | | | aligned | aligned | aligned | aligned | aligned | aligned |
| Inclination direction | | | Opposite | Opposite | Opposite | Opposite | Opposite | Opposite |
| (second and third lug groove) | | | | | | | | |
| Inclination direction | | | Opposite | Opposite | Opposite | Opposite | Opposite | Opposite |
| (third and fourth lug groove) | | | | | | | | |
| Shape of fifth lug groove | | | Curved | Curved | Curved | Curved | Curved | Curved |
| Radius of curvature R of fifth | | mm | 10 | 10 | 10 | 10 | 10 | 10 |
| lug groove | | | | | | | | |
| Groove area ratio | | % | 15 | 15 | 15 | 15 | 15 | 15 |
| (vehicle outer side) | | | | | | | | |
| Groove area ratio | | % | 31 | 31 | 31 | 31 | 31 | 31 |
| (vehicle inner side) | | | | | | | | |
| Chamfered/Radiused | | | Yes | Yes | Yes | Yes | Yes | Yes |
| Dry | Steering stability | | 8 | 7 | 9 | 8 | 8 | 7 |
| performance | performance | | | | | | | |
| | Travel time | Index | 101 | 98 | 107 | 105 | 105 | 102 |
| | | value | | | | | | |
| Wet | Steering stability | | 8 | 9 | 6 | 8 | 8 | 9 |
| performance | performance | | | | | | | |
| | Hydroplaning | Index | 103 | 105 | 98 | 104 | 104 | 105 |
| | resistance | value | | | | | | |
| | performance | | | | | | | |

| Uneven wear resistance | | 8 | 7 | 9 | 9 | 9 | 8 |
|---|---|---|---|---|---|---|---|
| performance | | | | | | | |
| Noise | Index | 100 | 98 | 103 | 102 | 102 | 99 |
| performance | value | | | | | | |

TABLE 4

| | | | Example | Example | Example | Example | Example | Example |
|---|---|---|---|---|---|---|---|---|
| | | | 17 | 18 | 19 | 20 | 21 | 22 |
| Base tread pattern | | | FIG. 2 | FIG. 2 | FIG. 2 | FIG. 2 | FIG. 2 | FIG. 2 |
| Distance | GL1/(TL/2) | % | 12 | 12 | 12 | 12 | 12 | 12 |
| | GL2/(TL/2) | % | 26 | 26 | 26 | 26 | 26 | 26 |
| | GL3/(TL/2) | % | 65 | 65 | 65 | 65 | 65 | 65 |
| | GL4/(TL/2) | % | 50 | 50 | 50 | 50 | 50 | 50 |
| Length of | L1/RW1 | % | 80 | 80 | 80 | 80 | 80 | 80 |
| lug | L2/RW2 | % | 40 | 40 | 40 | 40 | 40 | 40 |
| groove | L3/RW3 | % | 40 | 40 | 40 | 40 | 40 | 40 |
| | L4/RW4 | % | 40 | 40 | 40 | 40 | 40 | 40 |
| | L5a/RW4 | % | 20 | 20 | 20 | 20 | 20 | 20 |
| | L5b/RW5 | % | 20 | 20 | 20 | 20 | 20 | 20 |
| | L6/RW5 | % | 60 | 60 | 60 | 60 | 60 | 60 |
| Groove | W1 | mm | 10 | 10 | 10 | 10 | 10 | 10 |
| width | W2 | mm | 10 | 10 | 10 | 10 | 10 | 10 |
| | W3 | mm | 10 | 10 | 10 | 10 | 10 | 10 |
| | W4 | mm | 2 | 2 | 2 | 2 | 2 | 2 |
| | W4/W1 | % | 20 | 20 | 20 | 20 | 20 | 20 |
| Rib width | RW1/TL | % | 18 | 18 | 18 | 18 | 18 | 18 |
| | RW2/TL | % | 31 | 31 | 31 | 31 | 31 | 31 |
| | RW3/TL | % | 31 | 31 | 31 | 31 | 31 | 31 |
| | RW3/RW2 | % | 102 | 102 | 102 | 102 | 102 | 102 |
| | RW4/TL | % | 31 | 31 | 31 | 31 | 31 | 31 |
| | RW5/TL | % | 25 | 25 | 25 | 25 | 25 | 25 |
| Position of opening portion | | | Aligned | Not | Not | Not | Not | Not |
| (second and third lug groove) | | | | aligned | aligned | aligned | aligned | aligned |
| Position of opening portion | | | Aligned | Not | Not | Not | Not | Not |
| (third and fourth lug groove) | | | | aligned | aligned | aligned | aligned | aligned |
| Inclination direction | | | Opposite | Same | Opposite | Opposite | Opposite | Opposite |
| (second and third lug groove) | | | | | | | | |
| Inclination direction | | | Opposite | Same | Opposite | Opposite | Opposite | Opposite |
| (third and fourth lug groove) | | | | | | | | |
| Shape of fifth lug groove | | | Curved | Curved | Rectilinear | V-shape | Curved | Curved |
| Radius of curvature R of fifth | | mm | 10 | 10 | — | — | 5 | 8 |
| lug groove | | | | | | | | |
| Groove area ratio | | % | 15 | 15 | 15 | 15 | 15 | 15 |
| (vehicle outer side) | | | | | | | | |
| Groove area ratio | | % | 31 | 31 | 31 | 31 | 31 | 31 |
| (vehicle inner side) | | | | | | | | |
| Chamfered/Radiused | | | Yes | Yes | Yes | Yes | Yes | Yes |
| Dry | Steering stability | | 8 | 8 | 8 | 8 | 8 | 8 |
| performance | performance | | | | | | | |
| | Travel time | Index | 105 | 105 | 105 | 105 | 105 | 105 |
| | | value | | | | | | |
| Wet | Steering stability | | 8 | 8 | 8 | 8 | 8 | 8 |
| performance | performance | | | | | | | |
| | Hydroplaning | Index | 104 | 104 | 104 | 104 | 104 | 104 |
| | resistance | value | | | | | | |
| | performance | | | | | | | |

| Uneven wear resistance | | 7 | 7 | 8 | 8 | 8 | 9 |
|---|---|---|---|---|---|---|---|
| performance | | | | | | | |
| Noise | Index | 98 | 98 | 98 | 98 | 100 | 102 |
| performance | value | | | | | | |

TABLE 5

| | | | Example | Example | Example | Example | Example |
|---|---|---|---|---|---|---|---|
| | | | 23 | 24 | 25 | 26 | 27 |
| Base tread pattern | | | FIG. 2 | FIG. 2 | FIG. 2 | FIG. 2 | FIG. 2 |
| Distance | GL1/(TL/2) | % | 12 | 12 | 12 | 12 | 12 |
| | GL2/(TL/2) | % | 26 | 26 | 26 | 26 | 26 |
| | GL3/(TL/2) | % | 65 | 65 | 65 | 65 | 65 |
| | GL4/(TL/2) | % | 50 | 50 | 50 | 50 | 50 |
| Length of | L1/RW1 | % | 80 | 80 | 80 | 80 | 80 |
| lug | L2/RW2 | % | 40 | 40 | 40 | 40 | 40 |
| groove | L3/RW3 | % | 40 | 40 | 40 | 40 | 40 |
| | L4/RW4 | % | 40 | 40 | 40 | 40 | 40 |
| | L5a/RW4 | % | 20 | 20 | 20 | 20 | 20 |
| | L5b/RW5 | % | 20 | 20 | 20 | 20 | 20 |
| | L6/RW5 | % | 60 | 60 | 60 | 60 | 60 |
| Groove | W1 | mm | 10 | 10 | 10 | 10 | 10 |
| width | W2 | mm | 10 | 10 | 10 | 10 | 10 |
| | W3 | mm | 10 | 10 | 10 | 10 | 10 |
| | W4 | mm | 2 | 2 | 2 | 2 | 2 |
| | W4/W1 | % | 20 | 20 | 20 | 20 | 20 |
| Rib width | RW1/TL | % | 18 | 18 | 18 | 18 | 18 |
| | RW2/TL | % | 31 | 31 | 31 | 31 | 31 |
| | RW3/TL | % | 31 | 31 | 31 | 31 | 31 |
| | RW3/RW2 | % | 102 | 102 | 102 | 102 | 102 |
| | RW4/TL | % | 31 | 31 | 31 | 31 | 31 |
| | RW5/TL | % | 25 | 25 | 25 | 25 | 25 |
| Position of opening portion | | | Not | Not | Not | Not | Not |
| (second and third lug groove) | | | aligned | aligned | aligned | aligned | aligned |
| Position of opening portion | | | Not | Not | Not | Not | Not |
| (third and fourth lug groove) | | | aligned | aligned | aligned | aligned | aligned |
| Inclination direction | | | Opposite | Opposite | Opposite | Opposite | Opposite |
| (second and third lug groove) | | | | | | | |
| Inclination direction | | | Opposite | Opposite | Opposite | Opposite | Opposite |
| (third and fourth lug groove) | | | | | | | |
| Shape of fifth lug groove | | | Curved | Curved | Curved | Curved | Curved |
| Radius of curvature R of fifth lug | | mm | 50 | 55 | 10 | 10 | 10 |
| groove | | | | | | | |
| Groove area ratio | | % | 15 | 15 | 8 | 25 | 15 |
| (vehicle outer side) | | | | | | | |
| Groove area ratio | | % | 31 | 31 | 22 | 40 | 31 |
| (vehicle inner side) | | | | | | | |
| Chamfered/Radiused | | | Yes | Yes | Yes | Yes | No |
| Dry | Steering stability | | 8 | 8 | 8 | 8 | 7 |
| performance | performance | | | | | | |
| | Travel time | Index | 105 | 105 | 105 | 105 | 104 |
| | | value | | | | | |
| Wet | Steering stability | | 8 | 8 | 8 | 8 | 7 |
| performance | performance | | | | | | |
| | Hydroplaning | Index | 104 | 104 | 104 | 104 | 103 |
| | resistance | value | | | | | |
| | performance | | | | | | |

| | | | | | | |
|---|---|---|---|---|---|---|
| Uneven wear resistance | | 9 | 8 | 9 | 9 | 9 |
| performance | | | | | | |
| Noise performance | Index | 102 | 100 | 102 | 102 | 102 |
| | value | | | | | |

As is clear from Tables 1 and 5, the Examples 1 to 27 all had a better balance between dry performance, wet performance, uneven wear resistance performance, and noise performance than Conventional Example 1.

Comparative Example 1 with the lug groove that did not terminate within the rib had improved wet performance, however dry performance did not improve sufficiently and it performed worse than Conventional Example 1 in uneven wear resistance performance.

1. A pneumatic tire with a specified mounting direction with respect to a vehicle, the pneumatic tire comprising:
an annular tread portion that extends in a tire circumferential direction;
a pair of sidewall portions disposed on both sides of the tread portion;
a pair of bead portions disposed inward of the sidewall portions in a tire radial direction;
a first main groove disposed on a vehicle outer side of a tire equator in the tread portion that extends in the tire circumferential direction;
a second main groove disposed on a vehicle inner side of the tire equator in the tread portion that extends in the tire circumferential direction;
a third main groove disposed on the vehicle inner side of the second main groove in the tread portion that extends in the tire circumferential direction; and
a narrow groove disposed on the vehicle outer side of the first main groove in the tread portion that extends in the tire circumferential direction, a groove width of the narrow groove being less than groove widths of the first to third main grooves;
a distance GL1 from a center position of the first main groove to the tire equator being from 5% to 20% of a half-width TL/2 of a tire ground contact width TL;
a distance GL2 from a center position of the second main groove to the tire equator being from 20% to 35% of the half-width TL/2 of the tire ground contact width TL;
a distance GL3 from a center position of the third main groove to the tire equator being from 55% to 70% of the half-width TL/2 of the tire ground contact width TL;
a distance GL4 from a center position of the narrow groove to the tire equator being from 40% to 60% of the half-width TL/2 of the tire ground contact width TL;
a first rib being disposed on the vehicle inner side of the third main groove;
a second rib being disposed between the third main groove and the second main groove;
a third rib being disposed between the second main groove and the first main groove;
a fourth rib being disposed between the first main groove and the narrow groove;
a fifth rib being disposed on the vehicle outer side of the narrow groove; and
a plurality of first lug grooves, second lug grooves, third lug grooves, fourth lug grooves, fifth lug grooves, and sixth lug grooves being disposed in the tread portion,
the plurality of first lug grooves each including one end that reaches a ground contact edge on the vehicle inner side and another end that terminates within the first rib without communicating with the third main groove,
the plurality of second lug grooves each including one end that communicates with the third main groove and another end that terminates within the second rib,
the plurality of third lug grooves each including one end that communicates with the second main groove and another end that terminates within the third rib,
the plurality of fourth lug grooves each including one end that communicates with the first main groove and another end that terminates within the fourth rib,
the plurality of fifth lug grooves each intersecting the narrow groove and including one end that terminates within the fourth rib and another end that terminates within the fifth rib, and
the plurality of sixth lug grooves each including one end that reaches a ground contact edge on the vehicle outer side and another end that terminates within the fifth rib without communicating with the narrow groove.

2. The pneumatic tire according to claim 1, wherein the groove width of the narrow groove is from 10% to 60% of the groove width of the first main groove.

3. The pneumatic tire according to claim 1, wherein the groove widths of the first to third main grooves are from 8 mm to 16 mm, and the groove width of the narrow groove is from 1 mm to 6 mm.

4. The pneumatic tire according to claim 1, wherein a width of the third rib is from 80% to 120% of a width of the second rib.

5. The pneumatic tire according to claim 1, wherein opening portions of the second lug grooves and the third lug grooves are offset in the tire circumferential direction, and opening portions of the third lug grooves and the fourth lug grooves are offset in the tire circumferential direction.

6. The pneumatic tire according to claim 1, wherein the third lug grooves are inclined in an opposite direction to the second lug grooves with respect to a tire width direction, and the fourth lug grooves are inclined in an opposite direction to the third lug grooves with respect to the tire width direction.

7. The pneumatic tire according to claim 1, wherein one end proximal to the fourth rib and another end proximal to the fifth rib of each of the fifth lug grooves are located to one side in the tire circumferential direction of a point where the fifth lug groove and the narrow groove intersect.

8. The pneumatic tire according to claim 7, wherein each of the fifth lug grooves is curved toward one side in the tire circumferential direction.

9. The pneumatic tire according to claim 8, wherein a curved portion of each of the fifth lug grooves has a radius of curvature of from 8 mm to 50 mm.

10. The pneumatic tire according to claim 1, wherein
a region on the vehicle outer side of the tire equator in the tread portion has a relatively greater groove area ratio than a region on the vehicle inner side of the tire equator in the tread portion;
the groove area ratio of the region on the vehicle outer side of the tire equator in the tread portion ranges from 8% to 25%; and
the groove area ratio of the region on the vehicle inner side of the tire equator in the tread portion ranges from 22% to 40%.

11. The pneumatic tire according to claim 1, wherein the first to third main grooves and the narrow groove are chamfered or radiused.

12. The pneumatic tire according to claim 2, wherein the groove widths of the first to third main grooves are from 8 mm to 16 mm, and the groove width of the narrow groove is from 1 mm to 6 mm.

13. The pneumatic tire according to claim 12, wherein a width of the third rib is from 80% to 120% of a width of the second rib.

14. The pneumatic tire according to claim 13, wherein opening portions of the second lug grooves and the third lug grooves are offset in the tire circumferential direction, and opening portions of the third lug grooves and the fourth lug grooves are offset in the tire circumferential direction.

15. The pneumatic tire according to claim 14, wherein the third lug grooves are inclined in an opposite direction to the second lug grooves with respect to a tire width direction, and the fourth lug grooves are inclined in an opposite direction to the third lug grooves with respect to the tire width direction.

16. The pneumatic tire according to claim 15, wherein one end proximal to the fourth rib and another end proximal to the fifth rib of each of the fifth lug grooves are located to one side in the tire circumferential direction of a point where the fifth lug groove and the narrow groove intersect.

17. The pneumatic tire according to claim 16, wherein each of the fifth lug grooves is curved toward one side in the tire circumferential direction.

18. The pneumatic tire according to claim 17, wherein a curved portion of each of the fifth lug grooves has a radius of curvature of from 8 mm to 50 mm.

19. The pneumatic tire according to claim 18, wherein
a region on the vehicle outer side of the tire equator in the tread portion has a relatively greater groove area ratio than a region on the vehicle inner side of the tire equator in the tread portion;
the groove area ratio of the region on the vehicle outer side of the tire equator in the tread portion ranges from 8% to 25%; and
the groove area ratio of the region on the vehicle inner side of the tire equator in the tread portion ranges from 22% to 40%.

20. The pneumatic tire according to claim 19, wherein the first to third main grooves and the narrow groove are chamfered or radiused.
